(19) United States
(12) Patent Application Publication
(10) Pub. No.: US 2021/0276259 A1
(43) Pub. Date: Sep. 9, 2021

(54) HUMIDIFICATION IN A PNEUMATIC BUILD MATERIAL TRANSPORT SYSTEM

(71) Applicant: HEWLETT-PACKARD DEVELOPMENT COMPANY, L.P., Spring, TX (US)

(72) Inventors: Justin M. Roman, Cambrige, WA (US); Luke P. Sosnowski, Vancouver, WA (US); David R. Otis, Corvallis, OR (US)

(21) Appl. No.: 16/607,883

(22) PCT Filed: Apr. 7, 2018
(86) PCT No.: PCT/US2018/026629

§ 371 Date: Oct. 24, 2019

(51) Int. Cl. B29C 64/321; B29C 64/314; B29C 64/343; B29C 64/393; B29C 64/153; B33Y 30/00; B33Y 40/10; B33Y 50/02

(52) U.S. Cl. CPC B29C 64/321; B29C 64/314; B29C 64/343; B29C 64/393; B29C 64/357; B33Y 30/00; B33Y 40/10; B33Y 50/02; B29C 64/153

(57) ABSTRACT

In one example, a pneumatic transport system to transport build material in an additive manufacturing machine includes a conduit, a source of air pressure to pull or push a stream of air through the conduit, a source of build material to introduce a build material into the stream of air, a separator to remove build material from the stream of air, a flow meter downstream from the separator to measure the stream of air flowing through the conduit, and a controller operatively connected to the flow meter and to the source of air pressure and/or the sources of build material to, based on a measurement from the flow meter, adjust a rate of flow of the stream of air in the conduit.

### BACKGROUND

Additive manufacturing machines produce 3D (three-dimensional) objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices each defining that part of a layer or layers of build material to be formed into the object.

### DRAWINGS

FIG. 1 illustrates one example of a pneumatic transport system to transport build material in an additive manufacturing machine.

FIG. 2 is a block diagram illustrating one example of a controller in the pneumatic transport system shown in FIG. 1.

FIG. 3 is a flow diagram illustrating one example of a process to control the flow of build material in a pneumatic transport system such as that shown in FIG. 1.

FIG. 4 is a flow diagram illustrating one example of a process to control the humidity of transport air in a pneumatic transport system such as that shown in FIG. 1.

FIG. 5 illustrates another example of a pneumatic transport system to transport build material in an additive manufacturing machine.

FIG. 6 illustrates one example of a humidifier such as might be used in a pneumatic transport shown in FIGS. 1 and 5.

FIG. 7 illustrates a humidity control system such as might be used to implement a humidifier in a pneumatic transport system shown in FIGS. 1 and 5.

FIG. 8 illustrates another example of a pneumatic transport system to transport build material in an additive manufacturing machine.

The same part numbers designate the same or similar parts throughout the figures.

### DESCRIPTION

In some additive manufacturing machines, powdered build materials are used to form a solid object. Particles in each of many successive layers of build material powder are fused in a desired pattern to form the object. Build material powder may be transported through the machine pneumatically in a stream of air. One of the challenges transporting powdered build material pneumatically in an additive manufacturing machine is managing electrical surface charges on the powder. Surface charges on the small particles of the powdered build material can be large enough to cause the powder to behave in unpredictable or otherwise undesirable ways. Electrical surface charges dissipate more easily in humid air to better mitigate undesirable effects of surface charges on the build material powder.

Accordingly, in one example, a humidity control process for a pneumatic build material transport system in an additive manufacturing machine includes adding moisture to the stream of transport air upstream from the location where build material powder is added to the air stream, monitoring the humidity of the transport air, and adjusting the rate at which moisture is added to the stream of air to maintain the humidity within the desired range. In some additive manufacturing environments, it may be desirable to recirculate the humidified transport air (after powder separation) to retain moisture in the system and thus reduce power and water consumption.

In another example, a pneumatic transport system to transport build material in an additive manufacturing machine includes a conduit, a source of air pressure to pull or push a stream of air through the conduit, a humidifier to add moisture to the stream of air, a source of build material powder to introduce a build material powder into the stream of air downstream from the humidifier, and a separator downstream from the source of build material powder to remove build material powder from the stream of air for supplying powder to the build chamber. For recirculation, the transport system may include a first conduit downstream from the humidifier to carry the stream of air and the build material powder to the separator and a second conduit downstream from the separator to carry the stream of air back to the humidifier.

These and other examples shown in the figures and described below illustrate but do not limit the scope of the patent, which is defined in the Claims following this Description.

As used in this document, “and/or” means one or more of the connected things; and a “memory” means any non-transitory tangible medium that can embody, contain, store, or maintain information and instructions for use by a processor and may include, for example, circuits, integrated circuits, ASICs (application specific integrated circuits), hard drives, random access memory (RAM), read-only memory (ROM), and flash memory.

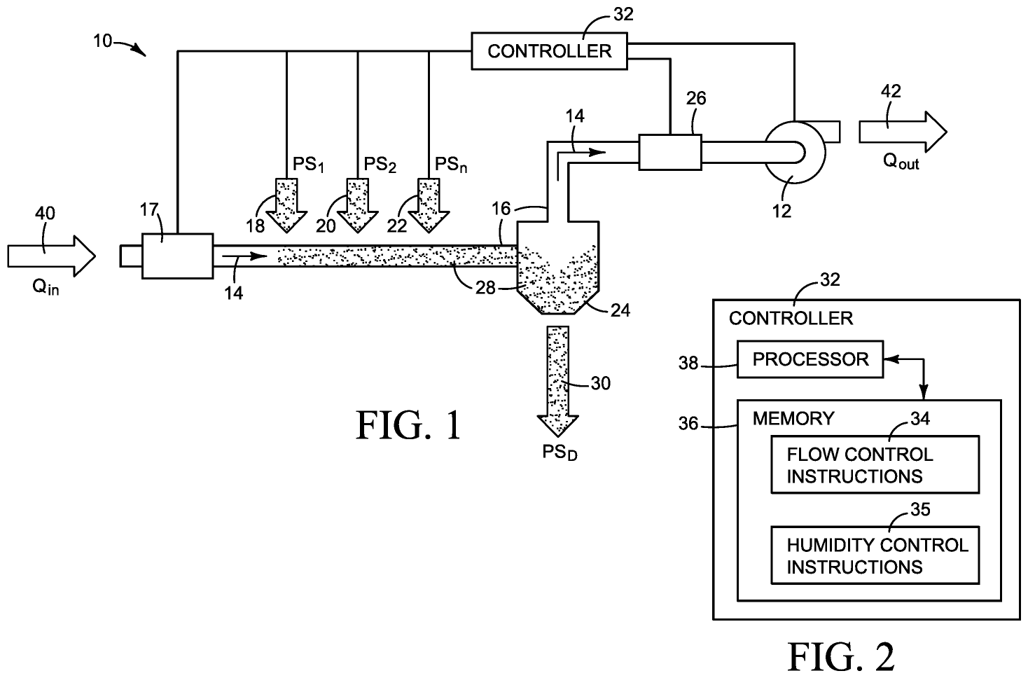

FIG. 1 illustrates one example of a pneumatic transport system 10 to transport powdered build material in an additive manufacturing machine. Referring to FIG. 1, transport system 10 includes a blower or other source of air pressure 12 to pull or push a single stream of air 14 through a conduit 16. System 10 also includes a humidifier 17, multiple sources of build material powder 18, 20, 22, a separator 24, and a flow meter 26. The presence of build material powder in system 10 during operation is indicated by stippling 28 in FIG. 1.

Humidifier 17 adds moisture to the stream of air 14 upstream from where build material is introduced into conduit 16 at sources 18-22. Each build material source 18-22 is configured to introduce a powdered build material into conduit 16 independent of the other sources. While an indefinite number of multiple build material sources PS₁, PS₂ . . . PSₙ are shown (called out by part numbers 18, 20, and 22) any number of sources may be used including a single source. Build material powders mix in air stream 14 as they are carried to separator 24. Separator 24 removes build material from the air stream and discharges it to a build chamber or an intermediate component, as indicated by stippled arrow 30 (labeled PS_{D}).

Flow meter 26 measures the flow rate of air stream 14 in conduit 16. Flow meter 26 is positioned downstream from separator 24 to prevent inaccuracies or even fouling that may be caused by build material 28 in conduit 16 upstream from separator 24. While any suitable flow meter may be used, it is expected that a venturi flow meter will be desirable in pneumatic transport systems for build material powders in additive manufacturing because they produce little pressure loss, they hold calibration well, and they can be designed and “printed” (manufactured with a 3D printer) faster than other types of measuring devices.

A controller 32 is operatively connected to air source 12, humidifier 17, build material sources 18-22, and flow meter 26. Controller 32 represents the programming, processing and associated memory resources, and the other electronic circuitry and components to control the transfer of build material 28 through conduit 16. In particular, controller 32 may include programming to adjust the rate at which moisture is added to the stream of air to maintain the humidity within the desired range and to adjust the rate of flow of air stream 14 in conduit 16 based on measurements from flow meter 24.

FIG. 2 is a block diagram illustrating one example of a controller 32 in the pneumatic transport system 10 shown in FIG. 1. Referring to FIG. 2, flow and humidity control programming may be implemented, for example, through instructions 34 and 35 residing on a controller memory 36 for execution by a processor 38. Controller 32 may be implemented as a local controller for flow control elements of transport system 10 and as a local controller for humidity control elements of transport system 10, or as part of a larger system or machine controller. In one example, where the flow rate is controlled with the rate at which a build material is introduced into air stream 14, controller 32 may be implemented as a local device controller for one or more of the build material sources 18-22. In another example, where the flow rate is controlled with air pressure, controller 32 may be implemented as a local device controller for air source 12.

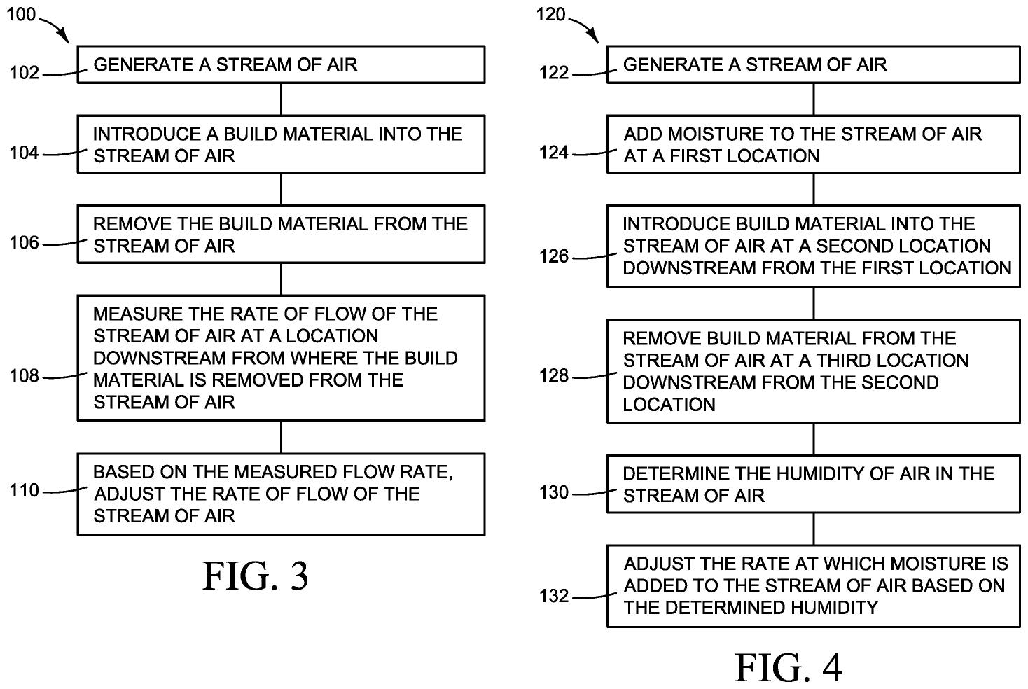

FIG. 3 is a flow diagram illustrating one example of a process 100 to control the flow of build material in transport system 10, for example by processor 38 in controller 32 executing flow control instructions 34. Part numbers in the description of process 100 refer to FIGS. 1 and 2. Referring to FIG. 3, process 100 includes generating a stream of air (block 102), for example with an air pressure source 12 pulling air through a conduit 16, and introducing build material into the air stream (block 104), for example with one or more build material sources 18-22. Build material is removed from the air stream (block 106), for example with a separator 24, and the rate of air flow is measured downstream from where build material is removed from the air stream (block 108), for example with a flow meter 26. The rate of air flow is adjusted based on the measured rate of air flow (block 110), for example by adjusting the rate at which build material is introduced into the air stream at one or more supplies 18-22 and/or by adjusting the speed of a blower 12 to change the magnitude of the force pulling air through conduit 16.

Air flow rate is measured by flow meter 26 and build material feed rate is controlled at each source PS₁ through PSₙ. If the rate of air flow in stream 14 is too slow, build material will settle out of the air stream in horizontal runs of conduit 16. Thus, the rate of air flow may be monitored at meter 26 as build material is introduced into conduit 16 at one or more sources PS₁ through PSₙ and, if the rate of air flow falls to a threshold, then the rate of air flow may be increased by reducing the amount of build material introduced into the stream at one or more sources PS₁ through PSₙ and/or by increasing power to blower 12. Also, it may be desirable in some circumstances to slow the rate of air flow based on measurements from meter 26, for example to reduce the magnitude of negative pressure in conduit 16 (to reduce leakage) or to reduce turbulence in separator 24. The rate of air flow may be slowed by increasing the amount of build material introduced into stream 14 at one or more sources PS₁ through PSₙ and/or by decreasing power to blower 12.

Referring to FIG. 1, air enters conduit 16 at an intake 40, as indicated by arrow Qᵢₙ. Air leaves conduit 16 at a discharge 42, the exhaust of blower 12 in this example, as indicated by arrow Qₒᵤₜ. Conduit 16 in FIG. 1 represents the one or more conduits carrying air through system 10. In one example, a blower 12 pulls air through conduit 16. A negative pressure pulling air through conduit 16 may be desirable for transporting build material for additive manufacturing to help reduce the risk of build material leaking from transport system 10.

Referring to FIG. 2, humidity control programming may be implemented, for example, through instructions 35 residing on controller memory 36 for execution by processor 38. Controller 32 may be implemented as a local controller for the humidity control elements of transport system 10 or as part of a larger system or machine controller.

FIG. 4 is a flow diagram illustrating one example of a process 120 to control the humidity of transport air 14 in system 10, for example by processor 38 in controller 32 executing humidity control instructions 35. Part numbers in the description of process 120 refer to FIGS. 1 and 2. Referring to FIG. 4, process 120 includes generating a stream of air (block 122), for example with an air pressure source 12 pulling air through a conduit 16, and adding moisture to the stream of air at a first location (block 124), for example with a humidifier 17. Build material is introduced into the stream of air at a second location downstream from the first location (block 126), for example with one or more build material sources 18-22 located downstream from humidifier 17. Build material is removed from the stream of air at a third location downstream from the second location (block 128), for example with a separator 24 located downstream from build material sources 18-22. The humidity and/or temperature of air in the stream of air is measured to determine the humidity of the air (block 130) and the rate at which moisture is added to the stream of air is adjusted based on the humidity determined at block 130 (block 132) to maintain the humidity within the desired range.

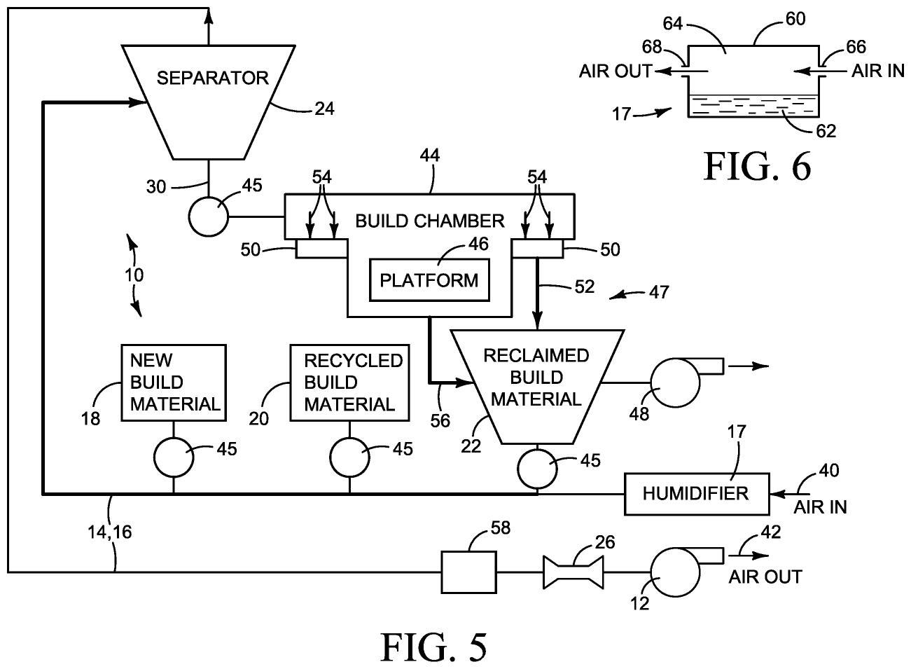

FIG. 5 illustrates another example of a pneumatic transport system 10 to transport build material in an additive manufacturing machine. Referring to FIG. 5, transport system 10 includes a blower 12 to pull a single stream of air 14 through a conduit 16, and a source of new build material 18, recycled build material 20, and reclaimed build material 22 to feed build material powder into air stream 14 in conduit 16. Arrows indicate the direction of air flow in FIG. 5. A feed control mechanism 45 may be used with each build material source to control the rate at which build material powder is introduced into conduit 16. Build material is removed from conduit 16 at a separator 24 and fed to a build chamber 44, for example through a feed control mechanism 45. Objects are formed on a platform 46 in build chamber 44. The presence of build material in conduit 16 during operation is indicated by a heavier line weight in FIG. 5.

System 10 in FIG. 5 also includes a humidifier 17 and a flow meter 26. Humidifier 17 adds moisture to the stream of air 14 upstream from where build material is introduced into conduit 16 at sources 18-22. Flow meter 26 measures the flow rate of air stream 14 in conduit 16 downstream from separator 24. A filter 58 may be used ahead of flow meter 26 to remove any residual build material powder from air stream 14. As described above with reference to FIGS. 1-3, the rate of air flow may be adjusted based on feedback from flow meter 26 to help maintained the desired flow of build material powder to separator 24.

In this example, reclaimed build material source 22 is part of a reclamation subsystem 47 that includes a source of air pressure 48 to draw air and thus unused build material from the perimeter of build chamber 44 through a manifold 50 and conduit 52, as indicated by arrows 54, and from the bottom of build chamber 44 through a conduit 56. Reclaimed build material source 22 may be implemented, for example, as a separator to remove build material from conduits 52, 54 for feeding to conduit 16.

FIG. 6 illustrates one example of a humidifier 17 such as might be used in a transport system 10 shown in FIG. 5. Referring to FIG. 6, humidifier 17 includes a chamber 60 holding a pool of water or other moisturizing liquid 62. Chamber 14 forms an air plenum 64 over water 62. The stream of air 14 enters plenum 64 through an inlet 66 and leaves through an outlet 68. Air is exposed to water 62 as it passes through plenum 64 where it can take-up moisture before build material powder is introduced at one or more sources 18-22 in FIG. 5.

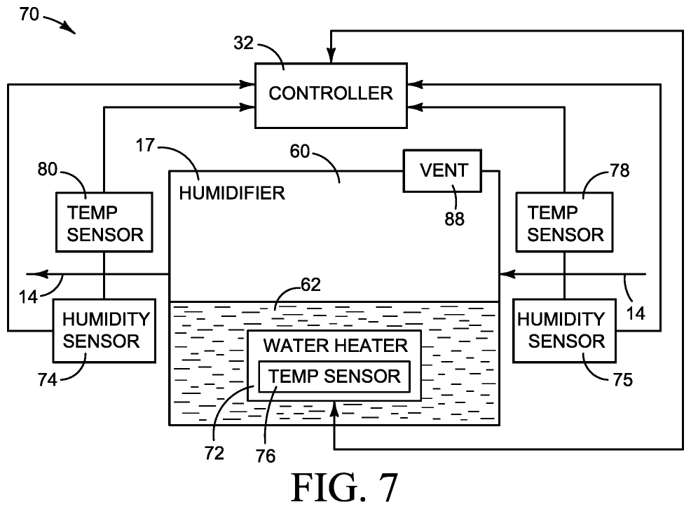

FIG. 7 illustrates a humidity control system 70 such as might be used to implement a humidifier 17 in a transport system 10 shown in FIGS. 1 and 5. Referring to FIG. 7, system 70 includes a humidifier 17 with a water heater 72 to heat water 62 in chamber 60. A downstream humidity sensor 74 measures the humidity of air stream 14 at the outlet of humidifier 17. System 70 may also include an upstream humidity sensor 75 to measure the humidity of air stream 14 at the inlet to humidifier 17. Controller 32 operatively connected to sensor 74 and water heater 72 adjusts the temperature of water 62 to maintain the desired humidity of air 14. Humidity control system 70 may include a temperature sensor 76 to measure the temperature of water 62 in chamber 60. Although temperature sensor 76 is shown as part of water heater 72 in FIG. 7, temperature sensor 76 could may implemented as a discrete part, separate from the water heater. Control system 70 may also include temperature sensors 78, 80 to measure the temperature of air stream 14 entering humidifier 17 and leaving humidifier 17, respectively.

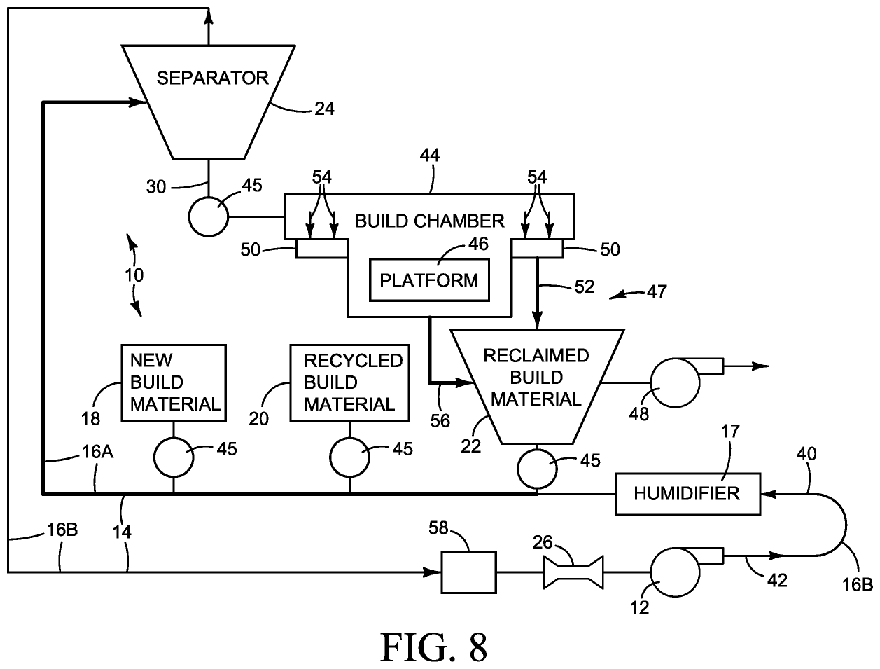

In another example, shown in FIG. 8, humidified air 42 that would otherwise be discharged from pneumatic transport system 10 is recirculated to humidifier 17 as intake air 40. In this example, conduit 16 includes a first conduit 16A downstream from humidifier 17 to carry a stream of air 14 with build material powder 28 (FIG. 1) to separator 24 and a second conduit 16B downstream from separator 24 to carry the stream of air back to humidifier 17. Also, as shown in FIG. 7, a vent or relief valve 88 may be used to help regulate the flow of air through humidifier 17.

The humidity and temperature of the transport air, measured by the downstream sensors 74 and 80 in FIG. 7, affect the characteristics of build material powder delivered to build chamber 44. If the relative humidity of the transport air is too low, build material powder may charge and clump. If the relative humidity of the transport air is too high, condensation may occur in the transport system. It may also be useful to know the humidity and temperature of the incoming air, measured by upstream sensors 75 and 78 in FIG. 7, to determine humidity lost or gained as transport air passes through system 10. While the level of humidity to achieve the desired characteristics for the transport air may vary depending on the type of the build material powder and other system parameters, testing indicates that a humidity in the range of 55% relative humidity at 25° C. to 75% relative humidity at 35° C. measured near the outlet from humidifier 17 allows electrical surface charges on a polyamide 12 (PA12) build material powder to dissipate more easily compared to lower humidity transport air, to help mitigate the undesirable effects of surface charges on the build material powder.

As noted at the beginning of this Description, the examples shown in the figures and described above illustrate but do not limit the scope of the patent. Other examples are possible. Therefore, the foregoing description should not be construed to limit the scope of the patent, which is defined in the following Claims.

“A” and “an” as used in the Claims means one or more.

1. A pneumatic transport system to transport build material in an additive manufacturing machine, the system comprising:
a conduit;
a source of air pressure to pull or push a stream of air through the conduit;
a humidifier to add moisture to the stream of air;
a source of build material powder to introduce a build material powder into the stream of air downstream from the humidifier; and
a separator downstream from the source of build material powder to remove build material powder from the stream of air.

2. The system of claim 1, where the conduit includes:
a first conduit downstream from the humidifier and upstream from the separator to carry the stream of air to the separator; and
a second conduit downstream from the separator and upstream from the humidifier to carry the stream of air back to the humidifier.

3. The system of claim 1, where the humidifier is to add moisture to the stream of air at a rate sufficient to maintain the humidity of air in the stream of air between 55% relative humidity at 25° C. and 75% relative humidity at 35° C.

4. The system of claim 1, comprising:
a flow meter downstream from the separator to measure the stream of air in the conduit; and
a controller operatively connected to the flow meter and to the source of air pressure and/or the source of build material powder to, based on a measurement from the flow meter, adjust a rate of flow of the stream of air in the conduit.

5. The system of claim 1, where the moisture includes water.

6. The system of claim 5, where the humidifier includes a pool of water exposed to the stream of air.

7. The system of claim 6, comprising:
a water heater to heat water in the pool;
a temperature sensor to sense a temperature of water in the pool;
a humidity sensor to sense a humidity of air in the stream of air; and
a controller operatively connected to the water heater, the temperature sensor and the humidity sensor, the controller to, based on a humidity from the humidity sensor, adjust a temperature of water in the pool.

8. A memory having instructions thereon that when executed cause a pneumatic build material transport system in an additive manufacturing machine to:
generate a stream of air;
add moisture to the stream of air at a first location;
introduce a build material powder into the stream of air at a second location downstream from the first location;
remove build material powder from the stream of air at a third location downstream from the second location;
determine a humidity of air in the stream of air; and
based on a determined humidity, adjust a rate at which moisture is introduced into the stream of air at the first location.

9. The memory of claim 8 having instructions thereon that when executed cause a pneumatic build material transport system in an additive manufacturing machine to recirculate the stream of air through the first, second and third locations.

10. The memory of claim 8 having instructions thereon that when executed cause a pneumatic build material transport system in an additive manufacturing machine to:
measure a rate of flow of the stream of air at a fourth location downstream from the third location; and
based on a measured rate of flow of the stream of air, adjust the rate at which build material powder is introduced into the stream of air and/or the magnitude of a force used to generate the stream of air.

11. The memory of claim 10, where the instructions to introduce a build material powder into the stream of air at a second location include instructions to introduce each of multiple build material powders into the stream of air at respective second locations.

12. A controller implementing the memory of claim 8.

13. A flow control process for a pneumatic build material transport system in an additive manufacturing machine, the process comprising:
pulling air through a conduit in a stream of air;
adding moisture to the stream of air at a first location;
introducing a build material powder into the stream of air at a second location downstream from the first location;
removing build material powder from the stream of air at a third location downstream from the second location;
measuring a rate of flow of the stream of air at a fourth location downstream from the third location; and
based on the measuring, adjusting the rate of flow of the stream of air by changing a rate at which build material powder is introduced into the stream of air and/or by pulling harder on the air.

14. The process of claim 13, comprising recirculating the stream of air through the first, second and third locations.

15. The process of claim 13, comprising:
determining a humidity of air in the stream of air; and
adjusting a rate at which moisture is added to the stream of air based on a determined humidity.
